(19) United States
(12) Patent Application Publication
(10) Pub. No.: US 2020/0151719 A1
(43) Pub. Date: May 14, 2020

(54) SYSTEMS AND METHODS FOR AGE-BASED AUTHENTICATION OF PHYSICAL CARDS

(71) Applicant: PAYPAL, INC., San Jose, CA (US)

(72) Inventor: Pankaj Sarin, Elkhorn, NE (US)

(21) Appl. No.: 16/189,521

(22) Filed: Nov. 13, 2018

(51) Int. Cl. G06Q 20/40; G06Q 20/34; G06Q 20/20; G06T 7/00; G06K 9/46; H04L 29/08

(52) U.S. Cl. CPC G06Q 20/401; G06Q 20/34; G06Q 20/208; G06T 2207/10088; G06K 9/46; H04L 67/306; G06T 7/0002

(57) ABSTRACT

Methods and systems are presented for authenticating a card transaction based on a predicted age of the payment card used in the card transaction. One or more images of a portion of the card is obtained while processing the card transaction. Physical characteristics of the card are determined based on analyzing the one or more images, and an estimated age of the card is derived based on the physical characteristics. An actual age of the card may be obtained from card data encoded on the card. The card transaction is authorized or deny based on a difference between the estimated age and the actual age of the card. An updated age of the card may be encoded in the card after the card transaction is authorized.

### BACKGROUND

The present specification generally relates to authenticating cards based on physical attributes, and more specifically, to authenticating card transactions based on a predicted age of the card used in a transaction at a point-of-sale system according to various embodiments of the disclosure.

### RELATED ART

While the popularity of electronic transactions using stored card data continues to increase, transactions conducted with physical cards at merchant locations still represent a very large market for card transactions, such as conducting a payment transaction with a merchant using a payment or funding source card. However, an increasing amount of payment card data (e.g., credit card numbers, expiration date, card verification value (CVV) etc.) that are used in these transactions are transmitted over an unsecured network (e.g., the Internet) and stored at remote locations (e.g., different merchant servers). The increasing exposure of the card data in combination of advanced hacking techniques means that it is easier than ever for malicious users to perform card fraud. For example, malicious users may obtain a large amount of card data by hacking into a merchant server where a merchant stores card data of its users. In another example, malicious users may also obtain card data by using a device installed at point-of-sale (POS) terminals of merchants to intercept card data.

These malicious users may then clone the genuine cards by inserting the stolen card data into counterfeit cards. The counterfeit cards may then be used to perform unauthorized transactions. While advanced technologies such as the use of EMV chips on the payment cards improve the security of data when performing card transactions at physical stores, card fraud is still prevalent. Thus, there is a need for better techniques for detecting the use of counterfeit cards in card transactions.

### BRIEF DESCRIPTION OF THE FIGURES

FIG. 1 is a block diagram illustrating an electronic transaction system according to an embodiment of the present disclosure;

FIG. 2 is a block diagram illustrating a card reader device according to an embodiment of the present disclosure;

FIG. 3 is a block diagram illustrating a risk analysis module according to an embodiment of the present disclosure;

FIG. 4 is a flowchart showing a process of authenticating a payment card transaction request according to an embodiment of the present disclosure; and

FIG. 5 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes methods and systems for authenticating a card transaction based on a predicted age of a payment card used in a card transaction. As used herein, a “payment card” is a physical card (usually made of plastic materials) that includes data associated with a funding account (e.g., a credit card account, a bank account, a gift card account, etc.). Example payment cards include credit cards, debit cards, automated teller machine (ATM) cards, gift cards, etc. that are configured to perform transactions such as purchase (e.g., payment) transactions, cash withdrawal transactions, and other fund-related transactions. Card data such as a card number (e.g., a credit card number, a debit card number, etc.), an expiration date, a card verification value (CVV), a card holder name may appear on the face of the physical card. Such data may also be stored in a magnetic strip and/or an EMV chip embedded in the card. When the payment card is used in a transaction, a device (e.g., a point-of-sale (POS) terminal, an ATM machine, etc.) may read the payment card data either from the magnetic strip (e.g., by swiping the card along a magnetic strip reader) or from the EMV chip (e.g., by inserting the card into the EMV chip reader). Note that while embodiments described herein are directed to payment cards, other types of cards are also contemplated, such as rewards cards, membership cards, and the like where the card is associated with an account or data for the account that may have value to fraudsters.

Through usages over time, the card may exhibit signs of deterioration (e.g., wear and tear). For example, after a number of times of swiping the card through a magnetic strip reader, scratches may appear on the magnetic strip of the card. Similarly, after a number of times of inserting the card into and removing the card from an EMV chip reader, scratches may appear on the exterior portions (e.g., the contacts) of the EMV chip. Furthermore, through the user's regular handling of the card (e.g., storing in a wallet, inserting the card into a slot in the wallet, removing the card from the slot of the wallet, etc.), the card may also exhibit other signs of wear and tear (e.g., plastic seal ripping off, discoloration of an area of the card, wearing down of the signature panel, carbon aggregated on the contacts of the EMV chip, circuits of the EMV chip thinning or breaking, a change in dimension and/or shape of the card, etc.). The extent of the physical deterioration of the card may correspond to an age of the card (e.g., how long the card has been in use, how many times the card has been used in transactions).

On the other hand, since a counterfeit card is made by inserting existing card data from a genuine card into another physical card (usually a brand new plastic card, for example, by encoding the card data in the magnetic strip of the counterfeit card and/or writing the card data into the EMV chip of the counterfeit card), the extent of physical deterioration exhibited by the counterfeit card may not correspond to the age of the genuine card. As such, according to various embodiments of the disclosure, a card transaction may be authenticated based on an estimated age of the physical card used in the transaction.

In some embodiments, as the card is used to perform a transaction at a POS terminal, an ATM machine, or other device capable of reading data from the card (e.g., the card is being swiped through a magnetic card reader, the card inserted into an EMV chip reader, etc.), one or more images of a portion of the card is obtained. For example, an optical sensor (e.g., an image sensor) may be incorporated into the magnetic card reader and/or the EMV chip reader such that as the card is swiped through the magnetic card reader and/or inserted into the EMV chip reader, one or more images of a portion of the card (e.g., the portion of the card that makes contact with the magnetic strip reader, the portion of the card that is inside the EMV chip reader, etc.) may be captured by the optical sensor. Instead of or in addition to the image sensor, a magnetic resonance imaging (MRI) scanner may be incorporated into the EMV chip reader such that as the card is inserted into the EMV chip reader, one or more MRI images of a portion of the card (e.g., the portion of the card that is inside the EMV chip reader, etc.) may be captured.

The images may be analyzed to determine an estimated age of the card. For example, a risk analysis system may analyze the images to determine one or more physical characteristics of the card. The physical characteristics determined by the risk analysis system for a card may include, but not limited to, a number of scratches detected within an area (e.g., the magnetic strip, the EMV chip contact area, etc.), a size of the scratches, a depth of the scratches, a size (e.g., dimension) of the circuits on the EMV chip, a color of an area of the card, a dimension of the portion of the card, a shape of the portion of the card, or other physical characteristics related to the deterioration (e.g., wear and tear) of the card.

Based on the determined physical characteristics of the card, the risk analysis system may derive an estimated age of the card. In some embodiments, the age may represent a total length of time that the card has been in use. In some embodiments, the age may represent a number of times that the card has been used in a transaction. Different users may handle their cards differently, and as such, the rate of deterioration (e.g., wear and tear) exhibited by cards associated with different users may be different. For example, a first user may handle her cards roughly and thus, her cards may exhibit a higher extent of deterioration than cards of a second user who handles her payment cards more delicately even across a similar amount of usage time. Thus, by collecting the images of cards and maintaining the age data (e.g., by maintaining a counter, by storing the activation date, etc.) of the cards, the risk analysis system may generate a usage profile for each user (and/or each card) based on the user's handling of the corresponding card. In some embodiments, the usage profile of a user may indicate a rate of deterioration. For example, the rate of deterioration may include a rate that the depth of a scratch increases over time (or over the number of times being used), a rate the width of a scratch increases over time (or over the number of times being used), a rate that carbon is building up on the contacts of the EMV chip over time, a rate that that the circuits of the EMV chip is thinning over time (or over the number of times being used), a rate that the plastic seal on the edge of the card is peeling off over time (or over the number of times being used), a rate that a color is fading in an area of the card over time (or over the number of times being used), a rate that the dimension of the card is changed, a rate that the shape of the card is changed, etc.

Furthermore, the usage profile of the user may also indicate deterioration characteristics. For example, a usage profile of a user may indicate that the card of the user tends to curve over time at a particular rate. A user profile of another user may indicate that the card of the user tends to have plastic seal peeled off at the edge of the card over time at a particular rate. Thus, the risk analysis system of some embodiments may derive the estimated age of a card based on the extent of deterioration determined on the card, deterioration characteristics of the card, and the usage profile of the user of the card.

The risk analysis system may then compare the estimated age of the card to an actual age of the card. The risk analysis system may deny the card transaction when it is determined that the estimated age of the card deviates from the actual age of the card by more a predetermined threshold, and may authorize the card transaction when it is determined that the estimated age of the card deviates from the actual age of the card by less than the predetermined threshold. When the card transaction is authorized, the risk analysis system may update the usage profile of the user (and/or the card) using the updated deterioration information determined from the images obtained while processing the transaction request.

In some embodiments, the risk analysis system may maintain a database that stores the actual ages of various cards corresponding to various accounts. As such, the risk analysis system may identify an account corresponding to the card based on the card data and/or the one or more images obtained from the POS terminal. For example, an optical character recognition (OCR) algorithm may be applied to the images to obtain a card number, which may then be used to map to an account. The risk analysis system may then retrieve the age associated with the card from the database and compare the actual age against the estimated age.

Since the card may be used in many places (e.g., out of the country where the card is issued, etc.), the risk analysis system may not be notified each time the card has been used. Thus, in some embodiments, instead of or in addition to storing the ages of various cards in the database, the age data that may be used to derive the actual age of each card may be stored (e.g., encoded) in the card itself. For example, the age data (e.g., a date when the card was activated, a counter indicating a number of times that the card has been used, etc.) may be encoded on the magnetic strip and/or the EMV chip. In these embodiments, the risk analysis system may obtain the information of the card read by the POS terminal, and may extract the age data of the card from the information. When the age data indicates a date when the card was activated, the risk analysis system may calculate the length of time that the card has been in use based on the date (e.g., the time elapsed between the date indicated in the information and a current date). The risk analysis system may then cause the POS terminal to authorize or deny the transaction based on the comparison between the estimated age and the actual age of the card. When the age data encoded in the card includes a counter representing the number of times that the card has been used, after the risk analysis system authorize the transaction, risk analysis system may update the age data. For example, the risk analysis system may increment the counter (e.g., by one) and cause the POS terminal to write the incremented counter back into the card.

In some embodiments, part or all of the risk analysis system may be implemented within the POS terminal such that the POS terminal may deny the transaction based on information (e.g., the actual age and the images of the card) obtained directly from the card without transmitting the card data to an external server. In some embodiments, part or all of the risk analysis system may be implemented within a server that is communicatively coupled to the POS terminal over a network such that the risk analysis system may detect potential transactions using different account and use such information to further improve the security of the transaction system.

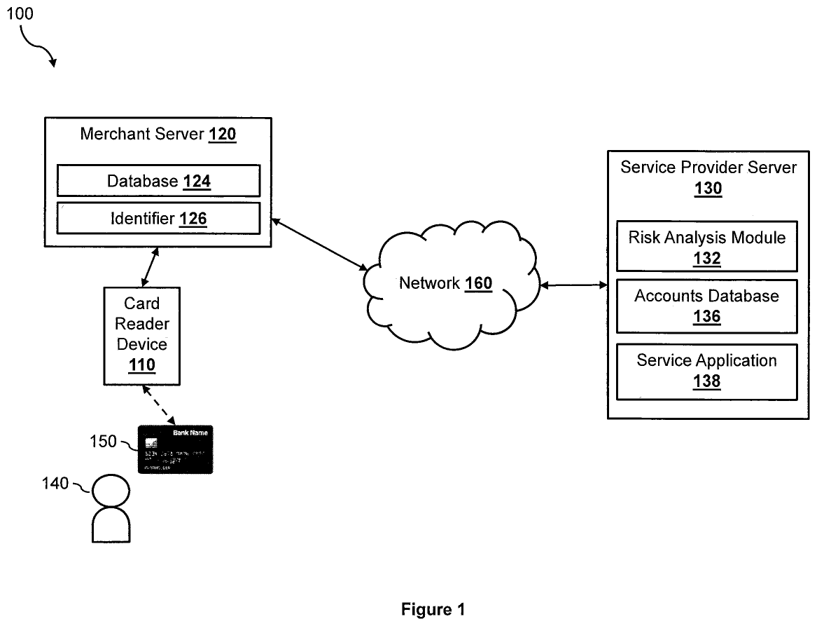

FIG. 1 illustrates an electronic transaction system 100 within which the risk analysis system may be implemented according to one embodiment of the disclosure. The electronic transaction system 100 includes a service provider server 130 associated with an online service provider, a merchant server 120, and a card reader device 110. The card reader device 110 may include a POS terminal associated with a merchant (e.g., a store, a gas station, etc.) and/or an ATM machine associated with a bank. In some embodiments, the card reader device 110 may cooperate with the merchant server 120 to perform transactions (e.g., payment transactions, withdrawal transactions, entrance to an event, access to rewards, etc.) by reading card data from a physical card, such as a card 150 of a user 140, and sending the card data to a processor. For example, the card reader device 110 may read card data (e.g., a card number, an expiration date, a CVV, etc.) from a card 150 (e.g., from the magnetic strip and/or the EMV chip of the card) of a user 140, and transmit the card data to the service provider server 130 to process a transaction.

The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet.

The card reader device 110, in one embodiment, may include at least one identifier, which may be implemented, for example, as operating system registry entries, identifiers associated with hardware of the user device (e.g., a media control access (MAC) address), or various other appropriate identifiers. The identifier 114 may include one or more attributes related to the merchant associated with the card reader device 110, such as a merchant identifier, a store location, etc. In various implementations, the identifier 114 may be passed with payment card data to the service provider server 130 to process a transaction.

The card reader device 110 may be communicatively coupled with the merchant server 120 associated with the merchant. The merchant server 120 and the card reader device 110, in various embodiments, may be maintained by a business entity (or in some cases, by a partner of a business entity that processes transactions on behalf of business entity). Examples of business entities include a merchant, a bank, etc., which offer various services such as items for purchase and withdrawal of money. The merchant server 120 may include a merchant database 124 that stores data associated with the items for purchase and/or data associated with its customers.

The merchant server 120, in one embodiment, may include at least one merchant identifier 126, which may be included as part of the one or more items made available for purchase so that, e.g., particular items are associated with the particular merchants. In one implementation, the merchant identifier 126 may include one or more attributes and/or parameters related to the merchant, such as business and banking information. The merchant identifier 126 may include attributes related to the merchant server 120, such as identification information (e.g., a serial number, a location address, GPS coordinates, a network identification number, etc.).

Even though only one card reader device 110 and one merchant server 120 are shown in FIG. 1, it has been contemplated that one or more card reader devices (each similar to the card reader device 110) and one or more merchant servers (each similar to the merchant server 120) may be communicatively coupled with the service provider server 130 via the network 160 within the system 100.

The service provider server 130, in one embodiment, may be maintained by an online service provider, which may provide online services (e.g., processing of payments, transfer of funds, risk evaluation of transaction requests, etc.). The service application server 138 may be configured to interact with the merchant server 120 and/or the card reader device 110 to evaluate a risk associated with a payment card transaction. In some embodiments, the service application server 138 may interact with the merchant server 120 and/or the card reader device 110 to provide an interface to receive a card transaction request. For example, upon obtaining card data from a card (e.g., reading the card data from the magnetic strip and/or the EMV chip of the card) by the card reader device 110, the card reader device 110 and/or the merchant server 120 may generate a transaction request that includes the card data, a transaction amount, and other information that identifies the merchant (e.g., the merchant identifier 126) and/or the card reader device 110. The card reader device 110 and/or the merchant server 120 may then transmit the transaction request to the service provider server 130 for processing. Thus, the service application 138 may include a processing application (not shown) for processing electronic transactions between a user and a merchant or between any two entities based on the received transaction request. In one implementation, the processing application assists with resolving electronic transactions through validation, delivery, and settlement. As such, the processing application settles indebtedness between a user and a merchant, wherein accounts may be directly and/or automatically debited and/or credited of monetary funds in a manner as accepted by the banking industry.

The service provider server 130, in one embodiment, may be configured to maintain one or more user accounts in an account database 136, each of which may include account information associated with one or more users (e.g., the user 140 associated with the card 150). For example, account information may include private financial information of users and merchants, such as one or more account numbers, passwords, credit card information, banking information, digital wallets used, transaction history, or other types of financial information. In certain embodiments, account information may also include card usage profiles indicating deterioration characteristics of cards associated with various user as disclosed herein.

The service provider server 130 may also include a risk analysis module 132 that implements the functionalities of the risk analysis system as disclosed herein. In some embodiments, the risk analysis module 132 may obtain physical characteristics (e.g., deterioration characteristics) of a physical payment card associated with a transaction request from the card reader device 110, analyze the physical characteristics to determine a likelihood that the physical card used for the transaction request is a counterfeit card, and authorize or deny the transaction request based on the likelihood.

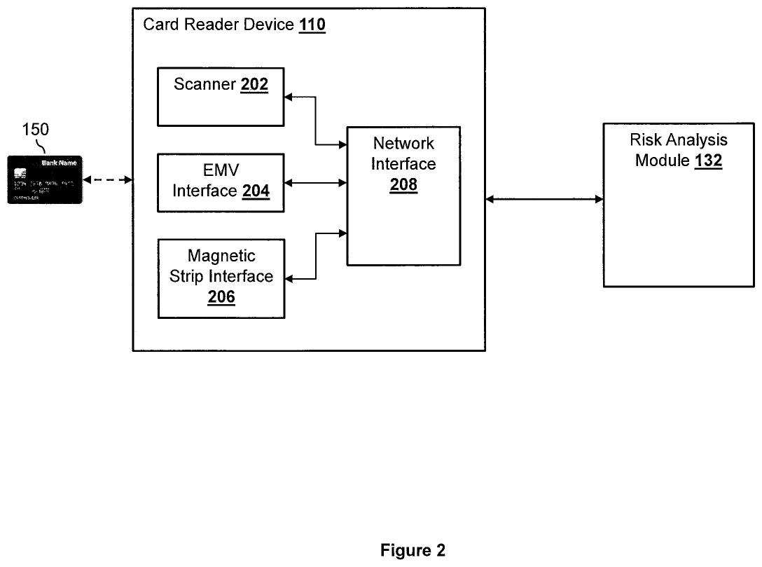

FIG. 2 illustrates a block diagram of the card reader device 110. As shown in FIG. 2, the card reader device 110 includes a scanner 202, an EMV interface 204 that may include an EMV chip reader and an EMV chip writer, a magnetic strip interface 206 that may include a magnetic strip reader and a magnetic strip writer, and a network interface 208. The magnetic strip interface 206, according to some embodiments, may include a slot (where the magnetic strip reader and writer are implemented) through which a user (e.g., the user 140) may swipe a physical card having a magnetic strip (e.g., the card 150). In some embodiments, the EMV interface may include a slot (where the EMV chip reader and writer are implemented) into which the user 140 may insert the card 150 having an EMV chip. As the card reader device 110 is used to process a transaction, the card reader device 110 may use the EMV interface 204 and/or the magnetic strip interface 206 to read card data from a physical card (e.g., the card 150). The card data obtained by the EMV interface 204 and/or the magnetic strip interface 206 may include a card number, an expiration date, a CVV, a card holder's name. In some embodiments, the card data may also include age data of the physical card that may indicate a length of time that the card has been in use and/or a number of transactions in which the card has been used. As the EMV interface 204 and/or the magnetic strip interface 206 read the card data from the EMV chip and/or the magnetic strip of the card 150, the scanner 202 may obtain one or more images of at least a portion of the card 150. The scanner 202 may include an optical sensor (e.g., a charge-couple device (CCD) sensor, a complementary metal oxide semiconductor (CMOS) sensor) for capturing one or more images of at least the portion of the card 150. In some embodiments, the scanner 202 may also include a magnetic resonance imaging (MRI) scanner for capturing one or more MRI images of at least the portion of the card. The card reader device 110 may then transmit the card data obtained from the card 150 and the images to the risk analysis module 132 via the network interface 208. Alternatively, the card reader device 110 may transmit the card data and the images to the risk analysis module 132 through the merchant server 120.

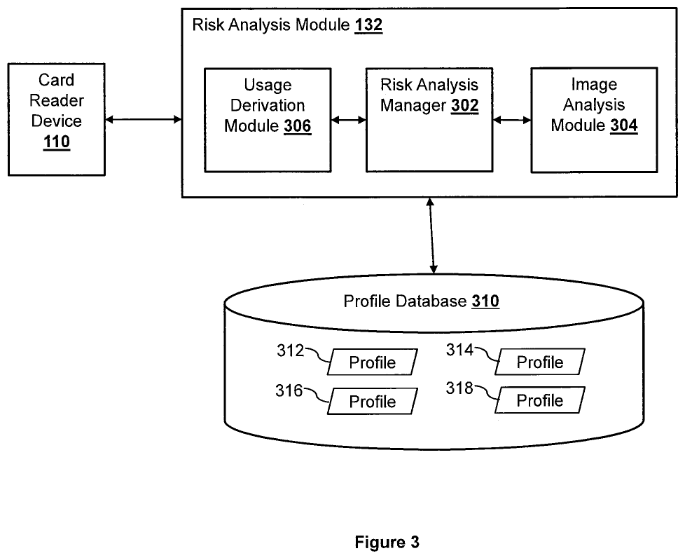

FIG. 3 illustrates a block diagram of the risk analysis module 132. As shown in FIG. 3, the risk analysis module 132 includes a risk analysis manager 302, an image analysis module 304 configured to analyze the images of the card 150 obtained from the card reader device 110 to determine physical characteristics (e.g., deterioration characteristics) of the card 150 based on images obtained from the card reader device 110, and a usage derivation module 306 configured to derive an estimated age of the card 150 based on the physical characteristics. In some embodiments, the usage derivation module 306 may access a usage profile of a user (e.g., the user 140) associated with the card 150 from the profile database 310. The usage profile indicates how the corresponding user normally handles the card 150, and may specifically indicate a rate of deterioration and deterioration characteristics based on the user's normal handling of the card 150. Thus, the usage derivation module 306 may derive the estimated age of the card based on both of the physical characteristics of the card 150 and one or more of the usage profiles (e.g., profile 312, 314, 316, and 318).

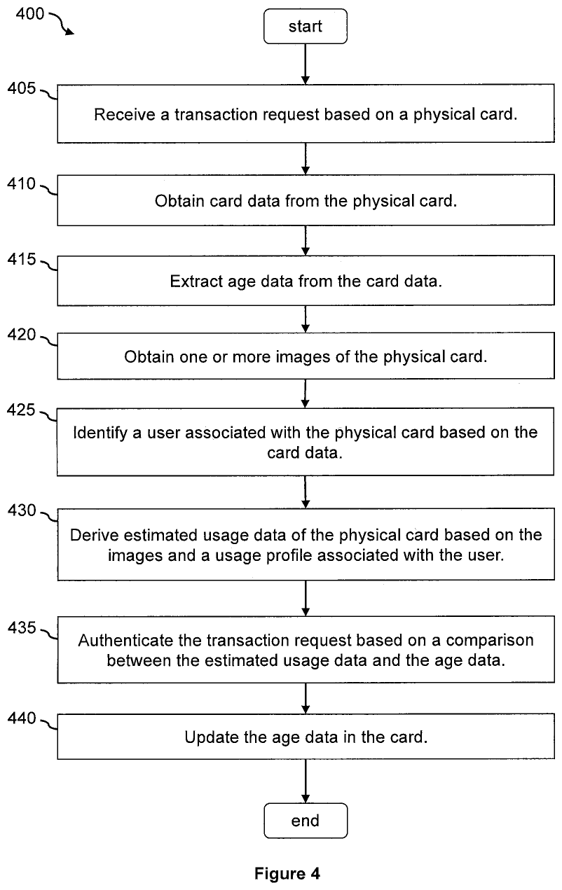

FIG. 4 illustrates a process 400 for performing an age-based authentication of a card transaction according to various embodiments of the disclosure. In some embodiments, the process 400 may be performed by the card reader device 110 and/or the risk analysis module 132. The process 400 begins by receiving (at step 405) a transaction request based on a payment card. For example, the card reader device 110 may receive an input (e.g., via a keypad or other types of input device of the card reader device 110) for initiating the transaction request. In an exemplary scenario, a cashier of a merchant associated with the card reader device 110 may provide inputs into the card reader device 110, indicating that a card is to be used for a transaction. The inputs may also include a transaction amount associated with the transaction. The card reader device 110 may then activate the EMV interface 204 and/or the magnetic strip interface 206 for obtaining card data from a card. The cashier or the user (e.g., 140) of the card 150 may perform an action that enables the card reader device 110 to obtain (e.g., read) the card data from the card 150. For example, the cashier or the user 140 may swipe the card 150 through the magnetic strip interface 206. In another example, the cashier or the user 140 may insert the card 150 having an EMV chip into the EMV interface 204.

The process 400 then obtains (at step 410) card data from the physical card. For example, as the card 150 is swiped through the magnetic strip interface 206, the magnetic strip reader of the magnetic strip interface 206 may read the card data from the magnetic strip of the card 150. In another example, after the card 150 is inserted into the EMV interface 204, the EMV chip reader of the EMV interface 204 may access the EMV chip of the card 150 to read the card data from the EMV chip. The card data obtained from the magnetic strip or the EMV chip of the card 150 may include data that can identify a funding source, including a card number (e.g., a credit card number, a debit card number, etc.), an expiration date, a CVV, a card holder's name, and other information. In some embodiments, the card data stored on the magnetic strip and/or the EMV chip of the card 150 may also include age data that may represent an age of the card 150. As such, the process 400 then extracts (at step 415) the age data from the card data.

It is known that the magnetic strip and the EMV chip stores the card data in a predetermined standardized format. For example, the data may be stored in the magnetic strip and the EMV chip based on a particular data structure having multiple data fields. Each data field may specify the information that is stored in the field. For example, the data structure may include a primary account number (PAN) data field that stores a 16-digit number (e.g., the card number), an expiration date field that stores the expiration date of the card 150, a CCV field that stores the three or four digit CCV number for the card 150, a card holder name field that stores the card holder's name, and other fields. The data structure may include reserved fields that are unused by the industry which may be used to store the age data according to various embodiments of the disclosure. For example, some of the fields of the EMV chip having tags that begin with “7DB” may be used to store the age data according to various embodiments of the disclosure. As such, the age data may be stored in a predetermined unused field in the data structure. Alternatively, the age data may be embedded within the least significant digit of the card number, as the last digit of the card number is merely a check digit and does not provide any information necessary for determining an account of the user 140. Thus, the card reader device 110 may extract the age data of the card 150 by obtaining data from the predetermined field of the data structure, or simply obtaining the entire card number including the least significant digit. As discussed herein, the age data may be indicated by a date when the card 150 was activated and/or by a counter representing a number of times the card 150 is used to perform a transaction.

The process 400 then obtains (at step 420) one or more images of the card. As discussed herein, the card reader device 110 includes a scanner 202 that may include an optical sensor and/or an MRI scanner. The scanner 202 may be implemented within (or near) the EMV Interface 204 and the magnetic strip interface 206 (e.g., inside the slots of the EMV interface 204 and the magnetic strip interface 206) such that the scanner 202 may be used to capture one or more images of at least a portion of the card 150 when the card is swiped through the magnetic strip interface 206 or is inserted into the EMV interface 204. In some embodiments, the scanner 202 may also include a flash (e.g., an LED light) that provides additional lighting on the card as the images are being captured. The card reader device 110 may then transmit the card data (including the age data) and the images captured by the scanner 202 to the service provider server 130 to process the transaction. In some embodiments, before processing the transaction, the service provider server 130 may use the risk analysis module 132 to determine a likelihood that the card (e.g., the card 150) used in the transaction is a counterfeit card.

Thus, the process 400 identifies (at step 425) a user associated with the payment card based on the card data, derives (at step 430) estimated usage data of the physical card based on the images and a usage profile associated with the user, and authenticates (at step 435) the transaction request based on a comparison between the estimated usage data and the age data. For example, upon receiving the card data and the images from the card reader device 110, the risk analysis module 132 may identify a user based on the card data (e.g., the card number, the card holder's name, etc.). The risk analysis module 132 may then retrieve a usage profile (e.g., the usage profile 312) corresponding to the identified user. The usage profile 312 may be generated based on previous card transactions (e.g., usages) using the card 150. For example, each time the card 150 is used in a transaction (e.g., a payment transaction, a cash withdrawal transaction, etc.), the risk analysis module 132 may obtain images of the card 150. Using the age data associated with the card 150 at the time the images were captured (e.g., the age data either being extracted from the card 150 itself as disclosed herein or stored by the risk analysis module 132 in the profile database 310), the risk analysis module 132 may generate the usage profile 312 for the card 150 based on extents and types of physical deterioration of the card 150 detected from the images in each of the previous transactions. In some embodiments, the risk analysis module 132 may generate a deterioration model for each of the cards (including the card 150) based on the extents and/or types of physical deterioration of the cards detected through the previous transactions. For example, the model may represent a rate of deterioration on the card 150 based on the length of time and/or number of times used in transactions. In some embodiments, when no usage profile is associated with the user (e.g., no images or usage data has been obtained from previous transactions associated with the card 150), the risk analysis module 132 may obtain a universal usage profile. For example, the risk analysis module 132 may generate the universal usage profile based on an average usage rate (e.g., an average deterioration rate) of all users associated with the service provider server 130. While using the universal usage profile to predict an estimated age of the card 150 may not be as accurate, it should provide at least an indicate as to the age of the card 150.

In some embodiments, the rate of deterioration may include a rate that the depth of a scratch increases over time (or over the number of times being used), a rate the width of a scratch increases over time (or over the number of times being used), a rate that carbon is building up on the contacts of the EMV chip over time, a rate that that the circuits of the EMV chip is thinning over time (or over the number of times being used), a rate that the plastic seal on the edge of the card is peeling off over time (or over the number of times being used), a rate that a color is fading in an area of the card over time (or over the number of times being used), a rate that the dimension of the card is changed, a rate that the shape of the card is changed, etc. The risk analysis module 132 may include the model as part of the usage profile 312 for the payment card 150. In some embodiments, the risk analysis module 132 may update the usage profile 312 based on subsequent transactions using the payment card 150 (e.g., using the images captured during the subsequent transactions).

The risk analysis manager 302 may use the image analysis module 304 to analyze the obtained images of the card 150. For example, the image analysis module 304 may use one or more image recognition techniques (e.g., a scale invariant feature transform (SIFT) algorithm) to extract local features of the card 150 from the images. The image analysis module 304 may determine, from the extracted local features, one or more physical characteristics of the card 150, which may include, but not limited to, a number of scratches detected within an area (e.g., the magnetic strip, the EMV chip contact area, etc.) of the card 150, a size of the scratches, a depth of the scratches, a size (e.g., dimension) of the circuits on the EMV chip of the card 150, a color of an area of the card 150, a dimension of the portion of the card 150, a shape of the portion of the card 150, or other physical characteristics related to the deterioration (e.g., wear and tear) of the card 150.

In some embodiments, the risk analysis manager 302 may use the usage derivation module 306 to derive an estimated age of the card 150 based on the physical characteristics determined by the image analysis module 304 and the usage profile 312 corresponding to the user of the card 150. For example, the image analysis module 304 may determine that contacts (e.g., the exterior surface) of the EMV chip on the card 150 has three scratches having a particular width and a particular depth based on the images. Furthermore, the image analysis module 304 may also determine that a particular amount of carbon is found on the contacts (e.g., the exterior surface) of the EMV chip on the card 150. In this example, the usage profile 312 may indicate a rate of scratches size (e.g., the width and the depth) increase (e.g., a particular size increase every 10 times of use, etc.) based on usage by the user 140 and a rate of carbon built-up on the contacts of the EMV chip (e.g., a particular amount of carbon built-up every week/month of use, etc.) based on usage by the user 140. By applying the physical characteristics of the card 150 into the model included in the usage profile 312, the usage derivation module 306 may determine an estimated age for the card 150. In some embodiments, the estimated age may indicate an estimated length of time that the card 150 has been in use (e.g., 2 years and 4 months) and/or an estimated number of times that the card 150 has been used in transactions (e.g., 432 times).

Since different users may handle their cards differently, their usage profiles may specify different rates of deterioration and/or different deterioration characteristics. For example, a first user may handle her cards roughly and thus, her usage profile may specify a higher rate of deterioration than a usage profile of a second user who handles her cards delicately. Furthermore, based on the particular way that the first user handles her cards, her usage profile may specify particular deterioration characteristics that may be different from the deterioration characteristics than the second user. For example, the usage profile of the first user may specify that her card tends to curve over time at a particular rate, while the usage profile of the second user may specify that her card tends to have the plastic seal coming off on the edge of the card at a particular rate. Thus, even with the same physical characteristics, the usage derivation module 306 may derive different estimated ages based on different usage profiles.

Referring back to FIG. 4, the process 400 then authenticates (at step 435) the transaction request based on a comparison between the estimated usage data and the actual age data. For example, the risk analysis manager 302 may obtain an actual age of the card 150 and then compares the actual age of the card 150 against the estimated age. In some embodiments, the risk analysis module 132 may store the actual age of each card (including the card 150) in the profile database 310. For example, when the card 150 was activated (or used for the first time), the risk analysis module 132 may record the date of the activation and/or initiate a counter (at 0) for the card 150. The risk analysis module 132 may then update the counter for the card 150 each time it receives and authorizes a transaction request.

In some embodiments, the actual age of the card 150 may be represented by age data stored on the card 150 (e.g., encoded within the magnetic strip of the card 150 and/or stored in the EMV chip) itself. For example, the usage derivation module 306 and/or the card reader device 110 may extract the age data from the card data as discussed above by reference to the step 415. As discussed above, the age data may indicate a time when the card was activated or used for the first time. The usage derivation module 306 may then calculate the actual age by determining a time elapsed between the time indicated in the card and a current time. In another example, the age data may include a counter indicating a number of times that the card 150 was used in a transaction, and more specifically, the number of times the card 150 was physically presented for a purchase and swiped in or inserted into a card reader device 110. The risk analysis manager 302 may then compare the actual age against the estimated age to determine whether the difference between the actual age and the estimated age exceeds a predetermined threshold (e.g., 20%, 30%, etc.). In some embodiments, the risk analysis manager 302 resides on the service provider server 130, which performs the comparison analysis. Alternatively, the risk analysis manager 302 may reside on the card reader device 110, where the age data may be provided to the card reader device 110 by the service provider server for the comparison analysis.

In some embodiments, the difference between the actual age and the estimated age represents a likelihood that the card 150 used in the transaction request is a counterfeit card—in other words, the card data obtained from the card 150 was stolen off another card (e.g., the genuine card) and illegally inserted into the card 150. When it is determined that the difference is less than the predetermined threshold (e.g., the likelihood that the card 150 is a counterfeit card is less than the predetermined threshold), the risk analysis manager 302 may authorize the transaction request and may transmit an approval signal to the card reader device 110. On the other hand, when it is determined that the difference exceeds the predetermined threshold (e.g., the likelihood that the card 150 is a counterfeit card is higher than the predetermined threshold), the risk analysis manager 302 may deny the transaction request and may transmit a denial signal to the card reader device 110.

In some embodiments, in addition to storing the age data in the profile database 310 and/or the card 150, information regarding an appearance of the card 150 may be stored in the profile database 310 and/or the card 150. As different cards may include different graphics (e.g., determined by the issuing bank and/or the user 140), the risk analysis module 132 may further use a color of an area of the card 150 to authenticate the card transaction request. For example, when the card 150 was activated or was used for the first time, the risk analysis module 132 may obtain one or more images of the card 150, for example, from a card reader device that was used to perform the first transaction. The risk analysis module 132 may then determine the color of a particular area (e.g., the top left corner where a logo of the issuing bank is located) of the card 150, and store color data representing the color in the profile database 310 and/or the card 150. For example, the color data may also be stored in one of the reserved data fields in the data structure of the EMV chip or the magnetic strip unused by the industry.

As such, for the card transaction request received from the card reader device 110, the risk analysis manager 302 may further use the image analysis module 304 to determine a color of the particular area of the card 150. The risk analysis manager 302 may also extract the color data of the card 150 either from the profile database 310 or from the card data extracted from the card 150. The risk analysis manager 302 may then determine (or update) the likelihood that the card 150 used in the card transaction request is a counterfeit card based on a difference between the color of the particular area of the card 150 determined from the images and the color indicated in the color data. For example, if the color determined from the images is different from the color indicated in the color data, the risk analysis manager 302 may increase the likelihood that the card 150 is a counterfeit card. However, if the color determined from the images is the same as the color indicated in the color data, the risk analysis manager 302 may decrease the likelihood that the card 150 is a counterfeit card.

In addition to color, the risk analysis module 132 of some embodiments may use any other appearance attributes of the card 150 (e.g., a thickness, a location of the card data such as the card number, the expiration date, the card holder's name appeared on the face of the card, etc.) to adjust and/or update the likelihood that the card 150 is a counterfeit card. In some embodiments, the risk analysis module 132 may use the updated likelihood to determine whether to authorize or deny the card transaction request.

The process 400 then updates (at step 440) the age data in the card. For example, after authorizing the transaction request, the risk analysis module 132 may cause the card reader device 110 to update the age data stored in the card. As discussed above, the age data obtained from the card may include a counter representing the number of times that the card 150 has been used in a transaction. Thus, the risk analysis manager 302 may increment the counter (e.g., adding one to the counter), and may cause the card reader device 110 to write the incremented counter to the card 150. When the age data was obtained in the EMV chip of the payment card 150, the risk analysis manager 302 may cause the card reader device 110 (e.g., send software instructions to the card reader device 110) to write the incremented counter to the EMV chip of the card 150 (e.g., writing the incremented counter to the predetermined data field of the data structure) while the card 150 is still inserted in the slot of the EMV interface 204 of the card reader device 110. When the age data was obtained from the magnetic strip of the card 150, the risk analysis manager 202 may cause the card reader device 110 (e.g., send software instructions to the card reader device 110) to instruct the user (e.g., the user 140) to swipe the card 150 through the slot of the magnetic strip interface 206 again and write the incremented counter to the predetermined data field in the data structure. In some embodiments, the risk analysis module 132 may also transmit the updated age data and the usage data of the card 150 to the merchant and/or the issuer of the card 150.

In some embodiments, once the transaction request is authorized, the risk analysis module 132 may use the physical characteristics (e.g., the deterioration characteristics) derived from the images of the card 150 to update the usage profile 312. For example, the risk analysis module 132 may use the physical characteristics to update the model (e.g., the rate of deterioration, the type of deterioration, etc.) to be used for evaluating subsequent transaction requests.

Even though in the embodiments illustrated above, the risk analysis module 132 was shown to be implemented external to the card reader device 110. In some embodiments, at least a portion of the risk analysis module 132 can be implemented within the card reader device 110 to improve the speed of authentication during a card transaction. For example, the functionalities of the image analysis module 304 and the usage derivation module 306 as described above may be incorporated into the card reader device 110. While the profile database 310 may be implemented externally (such that multiple POS devices can access the same usage profiles), the usage profiles may be retrieved from the profile database 310 at the time of the card transaction during the risk analysis process.

The unconventional way of using the appearance (e.g., the physical deterioration characteristics) of a card to authenticate a card transaction as disclosed herein may deter counterfeit card activities and prevent unauthorized card transactions in a manner that could not be accomplished using conventional card authentication methods. Furthermore, the risk analysis system is further improved by applying a personalized usage profile in each authentication such that a user's personal way of handling the card is taken into consideration in assessing the physical deterioration characteristics of the card.

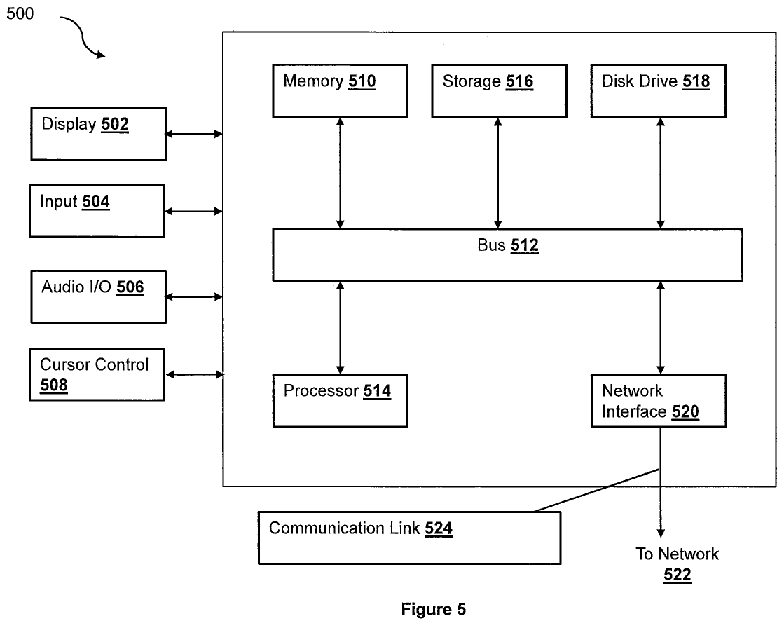

FIG. 5 is a block diagram of a computer system 500 suitable for implementing one or more embodiments of the present disclosure, including the service provider server 130, the merchant server 120, and the card reader device 180. In various implementations, the card reader device 110 may include a mobile cellular phone, personal computer (PC), laptop, wearable computing device, etc. adapted for wireless communication, and the service provider server 130 may include a network computing device, such as a server. Thus, it should be appreciated that the devices 110, 120, and 130 may be implemented as the computer system 500 in a manner as follows.

The computer system 500 includes a bus 512 or other communication mechanism for communicating information data, signals, and information between various components of the computer system 500. The components include an input/output (I/O) component 504 that processes a user (i.e., sender, recipient, service provider) action, such as selecting keys from a keypad/keyboard, selecting one or more buttons or links, etc., and sends a corresponding signal to the bus 512. The I/O component 504 may also include an output component, such as a display 502 and a cursor control 508 (such as a keyboard, keypad, mouse, etc.). The display 502 may be configured to present instructions for processing a payment card transaction and notifications indicating an approval or a denial of the payment card transaction request. An optional audio input/output component 506 may also be included to allow a user to use voice for inputting information by converting audio signals. The audio I/O component 506 may allow the user to hear audio. A transceiver or network interface 520 transmits and receives signals between the computer system 500 and other devices, such as another user device, a merchant server, or a service provider server via network 522. In one embodiment, the transmission is wireless, although other transmission mediums and methods may also be suitable. A processor 514, which can be a micro-controller, digital signal processor (DSP), or other processing component, processes these various signals, such as for display on the computer system 500 or transmission to other devices via a communication link 524. The processor 514 may also control transmission of information, such as cookies or IP addresses, to other devices.

The components of the computer system 500 also include a system memory component 510 (e.g., RAM), a static storage component 516 (e.g., ROM), and/or a disk drive 518 (e.g., a solid state drive, a hard drive). The computer system 500 performs specific operations by the processor 514 and other components by executing one or more sequences of instructions contained in the system memory component 510. For example, the processor 514 can perform the payment card transaction risk analysis functionalities described herein according to the process 400.

Logic may be encoded in a computer readable medium, which may refer to any medium that participates in providing instructions to the processor 514 for execution. Such a medium may take many forms, including but not limited to, non-volatile media, volatile media, and transmission media. In various implementations, non-volatile media includes optical or magnetic disks, volatile media includes dynamic memory, such as the system memory component 510, and transmission media includes coaxial cables, copper wire, and fiber optics, including wires that comprise the bus 512. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by the computer system 500. In various other embodiments of the present disclosure, a plurality of computer systems 500 coupled by the communication link 524 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system, comprising:
a non-transitory memory; and
one or more hardware processors coupled with the non-transitory memory and configured to read instructions from the non-transitory memory to cause the system to perform operations comprising:
in response to receiving a transaction request based on a physical card, obtaining card data from the physical card;
determining card usage from the card data;
deriving usage data representing an estimated age of the physical card based at least in part on analyzing a scan of a portion of the physical card; and
authenticating the transaction request based on a comparison between the derived usage data and the determined card usage.

2. The system of claim 1, wherein deriving the usage data comprises extracting physical characteristics of the physical card based on the analyzing of the scan.

3. The system of claim 2, wherein the physical characteristics comprise at least one of a circuit condition of circuits on an EMV chip of the physical card, an amount of detected carbon built-up on the EMV chip, a curvature of the portion of the physical card, or a dimension of a scratch detected on the portion of the physical card.

4. The system of claim 2, wherein the scan comprises an image of the portion of the physical card, and wherein the physical characteristics comprise a color of an area of the physical card.

5. The system of claim 1, wherein the scan comprises a magnetic resonance imaging (MRI) scan of the portion of the physical card.

6. The system of claim 1, wherein the card data and the scan of the portion of the physical card is obtained from a point-of-sale (POS) device of a merchant.

7. The system of claim 1, wherein the operations further comprise:
identifying a user associated with the physical card based on the card data; and
obtaining a usage profile representing a card deterioration rate associated with the user, wherein the usage data is derived further based on the usage profile.

8. The system of claim 1, wherein the operations further comprise:
incrementing a card usage counter; and
inserting the incremented card usage counter into the physical card.

9. The system of claim 8, wherein the card data is obtained from a magnetic strip on the physical card, and wherein inserting the incremented card usage counter into the physical card comprises writing the incremented card usage counter onto the magnetic strip of the physical card.

10. The system of claim 8, wherein the card data is obtained from an EMV chip of the physical card, and wherein inserting the incremented card usage counter into the physical card comprises writing the incremented card usage counter onto a predetermined data storage location of the EMV chip of the physical card.

11. The system of claim 1, wherein the operations further comprise determining a likelihood that the usage data derived from the scan corresponds to the card usage determined from the card data, wherein the transaction request is authenticated further based on the determined likelihood.

12. A method comprising:
receiving a card transaction request comprising card data obtained from a physical card and one or more images of the physical card;
determining physical characteristics of the physical card based on the one or more images;
determining a likelihood that the physical card is a counterfeit card based on the determined physical characteristics; and
authenticating the card transaction request based on the determined likelihood.

13. The method of claim 12, further comprising:
obtaining age data representing an actual age of the physical card; and
deriving an estimated age of the physical card based on the determined physical characteristics, wherein the likelihood that the physical card is a counterfeit card is determined based on a comparison between the estimated age and the actual age of the physical card.

14. The method of claim 12, wherein the physical characteristics comprise a color of a particular location of the physical card, wherein the method further comprises:
identifying an issuing bank of the physical card based on the card data, wherein the likelihood that the physical card is a counterfeit card is determined based on determining that the color of the particular location of the physical card corresponds to a logo of the issuing bank.

15. The method of claim 12, wherein the card data and the one or more images are obtained from an automated teller machine (ATM).

16. A non-transitory machine-readable medium having stored thereon machine-readable instructions executable to cause a machine to perform operations comprising:
in response to receiving a card transaction request based on a physical card, obtaining card data associated with a physical card;
extracting a card usage counter from the card data;
deriving usage data representing an estimated age of the physical card based at least in part on analyzing a scan of a portion of the physical card; and
authenticating the card transaction request based on a comparison between the derived usage data and the extracted card usage counter.

17. The non-transitory machine-readable medium of claim 16, wherein the operations further comprise:
identifying a user associated with the physical card based on the card data; and
obtaining a usage profile representing a card deterioration rate associated with the user, wherein the usage data is derived further based on the usage profile.

18. The non-transitory machine-readable medium of claim 17, wherein the operations further comprise updating the usage profile based on the derived usage data after authenticating the card transaction request.

19. The non-transitory machine-readable medium of claim 16, wherein the operations further comprise:
incrementing the card usage counter; and
inserting the incremented card usage counter into the physical card.

20. The non-transitory machine-readable medium of claim 1, wherein deriving the usage data comprises extracting physical characteristics of the physical card based on the analyzing of the scan, wherein the physical characteristics comprise at least one of a circuit condition of circuits on an EMV chip of the physical card, an amount of detected carbon built-up on the EMV chip, a curvature of the portion of the physical card, or a dimension of a scratch detected on the portion of the physical card.
